(19) United States
(12) Patent Application Publication
(10) Pub. No.: US 2017/0170624 A1
(43) Pub. Date: Jun. 15, 2017

(54) OPTICAL AMPLIFIER AND METHOD OF CONTROLLING EXCITATION LIGHT

(71) Applicant: FUJITSU LIMITED, Kawasaki-shi (JP)

(72) Inventors: Masayuki YOITA, Taitou (JP); Toshihiro Ohtani, Yokohama (JP)

(73) Assignee: FUJITSU LIMITED, Kawasaki-shi (JP)

(21) Appl. No.: 15/352,099

(22) Filed: Nov. 15, 2016

(30) Foreign Application Priority Data
Dec. 10, 2015 (JP) 2015-241261

(51) Int. Cl. H01S 3/13; H01S 3/0941; H01S 3/094; H01S 3/067; H01S 3/16

(52) U.S. Cl. CPC H01S 3/1305; H01S 3/06754; H01S 3/1608; H01S 3/094003; H01S 3/0941

(57) ABSTRACT

An optical amplifier includes a photodiode configured to measure power of an output light; a converter configured to convert the power of the output light into a voltage signal; and a processor configured to determine whether a difference between a level of the voltage signal and a predetermined potential is equal to or higher than a first predetermined value, change power of excitation light so that the level of the voltage signal approaches the predetermined value, when it is determined that the difference is equal to or higher than the first predetermined value, determine whether the power of the excitation light is equal to or higher than a second predetermined value, after the power of the excitation light is changed, and reduce the power of the excitation light, when it is determined that the power of the excitation light is equal to or higher than the second predetermined value.

### CROSS-REFERENCE TO RELATED APPLICATION

This application is based upon and claims the benefit of priority of the prior Japanese Patent Application No. 2015-241261, filed on Dec. 10, 2015, the entire contents of which are incorporated herein by reference.

### FIELD

The embodiments discussed herein are related to an optical amplifier and a method of controlling excitation light.

### BACKGROUND

In order to transmit an optical signal over a long distance using an optical fiber, an optical amplifier that compensates for the attenuation of the signal along the way has to be installed. As an optical amplifier that amplifies an optical signal, an erbium doped fiber amplifier (EDFA) that uses an optical fiber in which erbium, and the like are doped as rare earth elements, or a semiconductor laser amplifier that amplifies an incident optical signal by a pumping action in the laser active layer, or the like is known.

Among these optical amplifiers, the EDFA is capable of amplifying the wavelength band (1.55 μm band) of light having minimum optical fiber loss and obtaining the highest excitation efficiency and thus is often used. However, in order to obtain sufficient amplification, the EDFA has to have an optical fiber having a predetermined length, and thus increases in size compared with a semiconductor laser amplifier.

An optical amplifier is mounted on an optical transmission device, an optical repeater, or the like and has the function of controlling amplification, as follows, in addition to a function of amplifying input signal light. For example, in order to keep the power of output signal light at a certain level, such an optical amplifier has a function of detecting the power of output signal light and a function of determining the amplification factor in accordance with the power of the output signal light. In order for the amplification factor not to exceed (not to become higher than) a predetermined value at the time of receiving input signal light, the optical amplifier has a function of detecting the power of input signal light.

In recent years, devices, such as optical transmission devices, optical repeaters, and the like have been miniaturized, and miniaturization of an EDFA-type optical amplifier has thus been demanded. For such an EDFA-type optical amplifier, there has been proposed a technique for detecting the power of input signal light by using a detection circuit to detect the power of the output signal light without being provided with a detection circuit to detect the power of input signal light. As the related art, for example, Japanese Laid-open Patent Publication No. 2003-8117, or the like is disclosed.

However, if an attempt is made to detect the power of input signal light by using a measuring circuit to measure the power of output signal light (by monitoring the power of the output signal light), there is a problem in that it is not possible to correctly detect the power of input signal light because of the influence of automatic level control (ALC), which keeps the power of output signal light at a certain level. In particular, the higher the speed of the optical output level control, the more difficult accurate measurement. Accordingly, even if optical output level control is performed, it is desirable to enable detection of the power of input signal light with high precision without using a detection circuit to detect the power of input signal light.

### SUMMARY

According to an aspect of the invention, an optical amplifier that amplifies input light by an excitation effect of a rare earth element-doped optical fiber and outputs output light, the optical amplifier includes a photodiode configured to measure power of the output light; a converter configured to convert the power of the output light measured by the photodiode into a voltage signal; and a processor coupled to the converter and configured to determine whether a difference between a level of the voltage signal and a predetermined potential is equal to or higher than a first predetermined value, change power of the excitation light so that the level of the voltage signal approaches the predetermined value, when it is determined that the difference is equal to or higher than the first predetermined value, determine whether the power of the excitation light is equal to or higher than a second predetermined value, after the power of the excitation light is changed, and reduce the power of the excitation light, when it is determined that the power of the excitation light is equal to or higher than the second predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration diagram of an optical amplifier;

FIG. 2 is a diagram illustrating an example of a configuration diagram of an optical amplifier according to a first embodiment;

FIG. 3 is an example of a flowchart illustrating control, performed by an excitation light control unit, from generation of excitation light by an excitation light generation unit to weakening the power of the excitation light;

FIG. 4 is a diagram illustrating an example of relationships among input signal light, the total loss of an optical amplification unit and a branching unit, and the like, and the measurement power measured by a monitoring unit;

FIG. 5 is a diagram illustrating a measurable range measured by a monitoring unit based on the relationship between the power of the input signal light and the total loss of the optical amplifier;

FIG. 6 is a diagram illustrating an example of a signal state at each position by using a time chart;

FIG. 7 is a diagram illustrating an example of a configuration diagram of an optical amplifier according to a second embodiment; and

FIG. 8 is a diagram illustrating an example of a configuration diagram of an optical amplifier according to a third embodiment.

### DESCRIPTION OF EMBODIMENTS

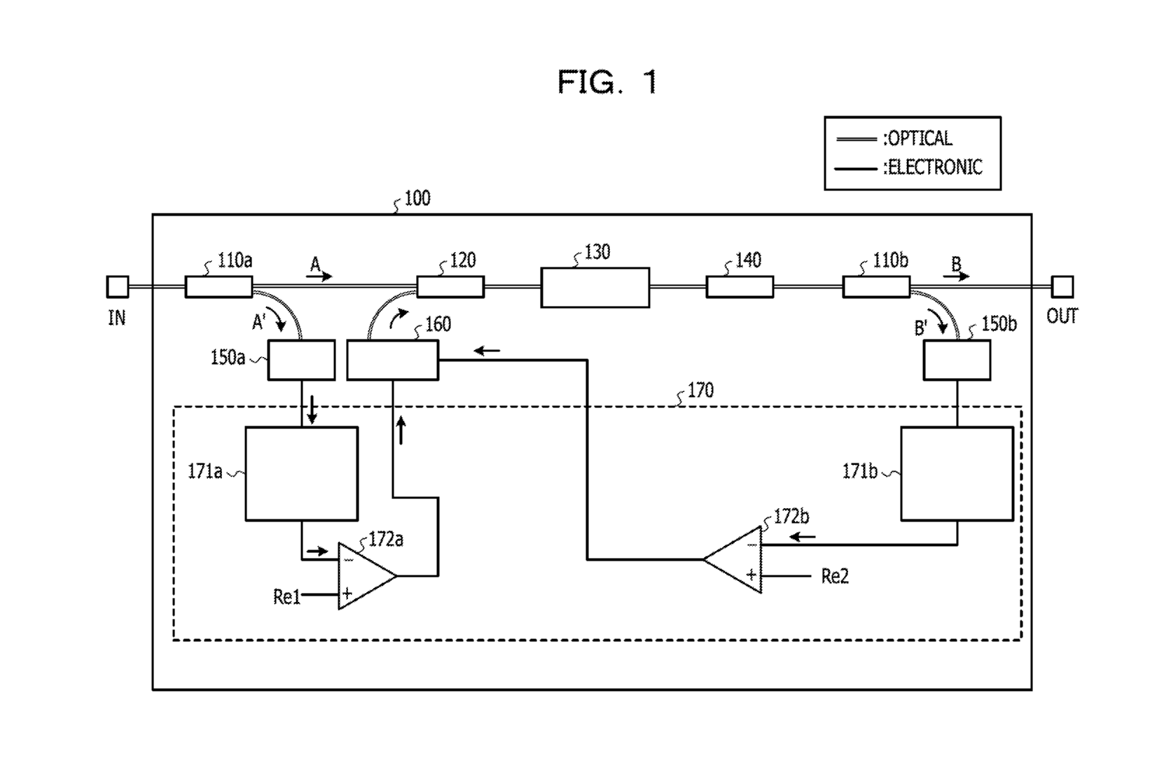

FIG. 1 is a diagram illustrating an example of a configuration diagram of an optical amplifier 100. The optical amplifier 100 includes branching units 110a and 110b, a multiplexing unit 120, an optical amplification unit 130, an optical isolator 140, monitoring units 150a and 150b, an excitation light generation unit 160 and an excitation light control unit 170.

Reference symbol IN in FIG. 1 denotes an input unit of signal light, and reference symbol OUT denotes an output unit of signal light. The branching unit 110a branches the signal light input from the input unit IN to the optical amplifier 100 into signal light A to be sent to the multiplexing unit 120 and signal light A′ to be sent to the monitoring unit 150a. The branching unit 110b branches the signal light that has passed through the optical isolator 140 into signal light B to be sent to the output unit OUT and signal light B′ to be sent to the monitoring unit 150b. The branching units 110a and 110b are branch couplers, for example.

The multiplexing unit 120 multiplexes the excitation light output from the excitation light generation unit 160 and one of the signal light A (input signal light) branched by the branching unit 110a. The multiplexing unit 120 is an optical coupler for optical multiplexing, for example.

The optical amplification unit 130 receives output light from the multiplexing unit 120 and amplifies the signal light A. That is to say, the signal light A is amplified by the excitation light output from the excitation light generation unit 160. The optical amplification unit 130 is an optical fiber in which, for example, a rare earth element, for example erbium, or the like is doped. At this time, the optical fiber may have the structure of an optical waveguide.

Specifically, excitation light having a wavelength that is shorter than the wavelength of the signal light A to be amplified by 100 nm, for example is input. Thereby, the doped elements in the optical fiber are excited to cause stimulated emission, and thus the input signal light A is amplified.

The optical isolator 140 blocks the returning light (returning light that is reflected from a subsequent stage device, or the like) of the signal light output from the optical amplification unit 130. In this manner, the optical isolator 140 blocks so-called returning light and allows only the signal light in the forward direction (the direction from the optical amplification unit 130 to the output unit OUT) so as to inhibit damage to the laser, destabilization, the occurrence of noise due to interference, and the like.

The monitoring unit 150a measures the power (intensity) of the signal light input into the input unit IN of the optical amplifier 100. Specifically, the monitoring unit 150a measures the power of the signal light A′ that is output from the branching unit 110a. The monitoring unit 150a then obtains the power of the signal light input into the input unit IN from the power of the measured signal light A′.

The monitoring unit 150b measures the intensity of the signal light output from the output unit OUT of the optical amplifier 100. Specifically, the monitoring unit 150b measures the intensity of the signal light B′ that is output from the branching unit 110b. The monitoring unit 150b then obtains the intensity of the signal light output from the output unit OUT from the intensity of the measured signal light B′. The monitoring units 150a and 150b are photodiodes (PDs), for example.

The excitation light generation unit 160 outputs the excitation light having the power level in accordance with the obtained output power. The excitation light generation unit 160 is a laser diode (LD), for example.

The excitation light control unit 170 includes current-to-voltage conversion units 171a and 171b and signal comparison units 172a and 172b.

The current-to-voltage conversion unit 171a converts the value (current value) indicating the power of the signal light A′ measured by the monitoring unit 150a into a voltage value. If the input current value is lower than a predetermined value, the current-to-voltage conversion unit 171a amplifies the current value if demanded. The current-to-voltage conversion unit 171a is, for example a circuit using a central processing unit (CPU) or an electric circuit for current-to-voltage conversion.

The current-to-voltage conversion unit 171b converts the value (current value) indicating the intensity of the signal light B′ measured by the monitoring unit 150b into a voltage value. If the input current value is lower than a predetermined value, the current-to-voltage conversion unit 171b amplifies the current value on demand. The current-to-voltage conversion unit 171b is, for example a circuit using a CPU or an electric circuit for current-to-voltage conversion.

The signal comparison unit 172a outputs a signal denoting whether or not the excitation light is outputted to the excitation light generation unit 160 based on the result of the comparison between the voltage converted by the current-to-voltage conversion unit 171a and each reference potential (Re1). The signal comparison unit 172a is a comparator, which is a kind of a circuit element, for example.

The signal comparison unit 172b outputs a signal for controlling the power of the excitation light output from the excitation light generation unit 160 based on the result of the comparison between the voltage converted by the current-to-voltage conversion unit 171b and the reference potential (Re2). The signal for controlling the power of the excitation light is produced by a method of using a bias potential, for example. The signal comparison unit 172b is a comparator, which is a kind of a circuit element, for example.

Next, a description will be given of the operation of the optical amplifier 100. When signal light is input, the optical amplifier 100 measures the signal light A′, which is branched by the branching unit 110a, by using the monitoring unit 150a. If the value of the voltage that is converted based on the measurement result becomes equal to or higher than a predetermined reference potential (Re1), the excitation light control unit 170 performs control so as to output the excitation light from the excitation light generation unit 160. If the measured voltage value becomes lower than or equal to the predetermined reference potential (Re1), the excitation light control unit 170 performs control so as not to output (to stop) the excitation light.

The excitation light output from the excitation light generation unit 160 is multiplexed with the signal light A branched from the branching unit 110a and is input into the optical amplification unit 130.

In this manner, the signal light input into the optical amplification unit 130 is amplified in the optical amplification unit 130.

The signal light output from the optical amplification unit 130 passes through the optical isolator 140 and is then branched by the branching unit 110b. A part of the signal light B is output from the output unit OUT to the outside, and the other part of the signal light B′ is input into the monitoring unit 150b.

The monitoring unit 150b outputs (sends) the information regarding the measured signal light B′ to the excitation light control unit 170. The excitation light control unit 170 controls the power of the excitation light based on the information received from the monitoring unit 150b.

### First Embodiment

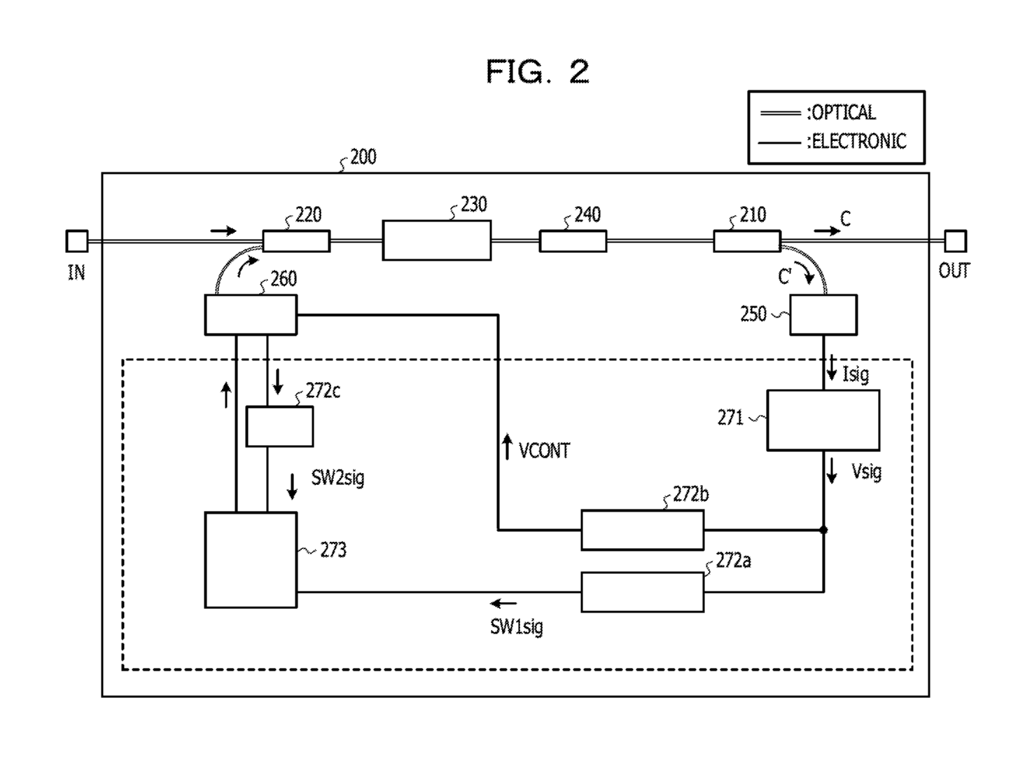

Next, FIG. 2 illustrates an example of a configuration diagram of an optical amplifier 200 according to a first embodiment. The optical amplifier 200 includes a branching unit 210, a multiplexing unit 220, an optical amplification unit 230, an optical isolator 240, a monitoring unit 250, an excitation light generation unit 260, and an excitation light control unit 270.

In the configuration described above, the branching unit 210, the multiplexing unit 220, the optical amplification unit 230, the optical isolator 240, the monitoring unit 250, and the excitation light generation unit 260 correspond to the branching unit 110b, the multiplexing unit 120, the optical amplification unit 130, the optical isolator 140, the monitoring unit 150b, and the excitation light generation unit 160 in FIG. 1 respectively, and thus their descriptions will be omitted.

The excitation light control unit 270 performs on/off (light emission/stop) control of the excitation light in the excitation light generation unit 260 and control of power adjustment of the excitation light based on the measurement result of the monitoring unit 250 and the power of the excitation light at that time.

The excitation light control unit 270 includes a current-to-voltage conversion unit 271, signal comparison units 272a, 272b and 272c, and the output control unit 273. The current-to-voltage conversion unit 271 is the same as the current-to-voltage conversion unit 171b in FIG. 1, and thus its description will be omitted.

The signal comparison unit 272a receives the output (Vsig) from the current-to-voltage conversion unit 271. The signal comparison unit 272a outputs a signal SW1sig that switches light emission/stop to the output control unit 273 based on the received voltage signal Vsig. For example, if the voltage signal Vsig is higher than a predetermined reference potential (Ref1), the signal comparison unit 272a outputs a signal (a control signal that emits excitation light) having an “H” level to the output control unit 273.

The signal comparison unit 272b receives the output (Vsig) from the current-to-voltage conversion unit 271. The signal comparison unit 272b then controls the power of the excitation light output from the excitation light generation unit 260 based on the received voltage signal Vsig. For example, the signal comparison unit 272b outputs a control signal VCONT (for example, a bias potential) to the excitation light generation unit 260 such that the voltage signal Vsig approaches a predetermined power reference potential (Ref2).

The signal comparison unit 272c outputs a signal SW2sig to the output control unit 273 in accordance with the power of the excitation light output from the excitation light generation unit 260. If the power of the excitation exceeds a predetermined reference potential (Ref3), the signal comparison unit 272c sends a signal that stops emission of the excitation light. For example, when the excitation light generation unit 260 uses an excitation laser, the excitation light generation unit 260 monitors the backlight output from the back of the excitation laser. Further, if the power of the backlight, or the power of the excitation light obtained based on the power of the backlight (being output from the front face of the laser) exceeds the predetermined reference potential (Ref3), the signal comparison unit 272c outputs an “H” level signal for stopping emission of the excitation light to the output control unit 273. When the signal comparison unit 272c is outputting the “H” level signal for stopping emission of the excitation light, until the signal from the signal comparison unit 272a changes from the “H” level signal to the “L” level signal (for example, having a reference potential (Ref4) equal to the reference potential (Ref1), and until becoming lower than the reference potential (Ref4)) the signal comparison unit 272c outputs the “H” level signal.

When the output control unit 273 receives input of the “H” level signal from the signal comparison unit 272a, the output control unit 273 performs control so as to cause the excitation light generation unit 260 to generate (output) the excitation light. When the output control unit 273 receives input of the “L” level signal from the signal comparison unit 272a, the output control unit 273 performs control so as to cause the excitation light generation unit 260 to stop emission of the excitation light. When the output control unit 273 receives input of the “L” level signal from the signal comparison unit 272a, the output control unit 273 may perform control so as to cause the excitation light generation unit 260 to weaken the excitation light (to lower the excitation light below a predetermined value).

The excitation light control unit 270 is a board module produced by disposing one or a plurality of circuit devices that are capable of realizing the current-to-voltage conversion unit 271, the signal comparison units 272a, 272b and 272c, and the output control unit 273 on a wiring board not illustrated in FIG. 2, for example. It is possible to realize the circuit device by individually integrating an electric circuit for current-voltage conversion, a comparator, and an exclusive OR (XOR) logic circuit, for example.

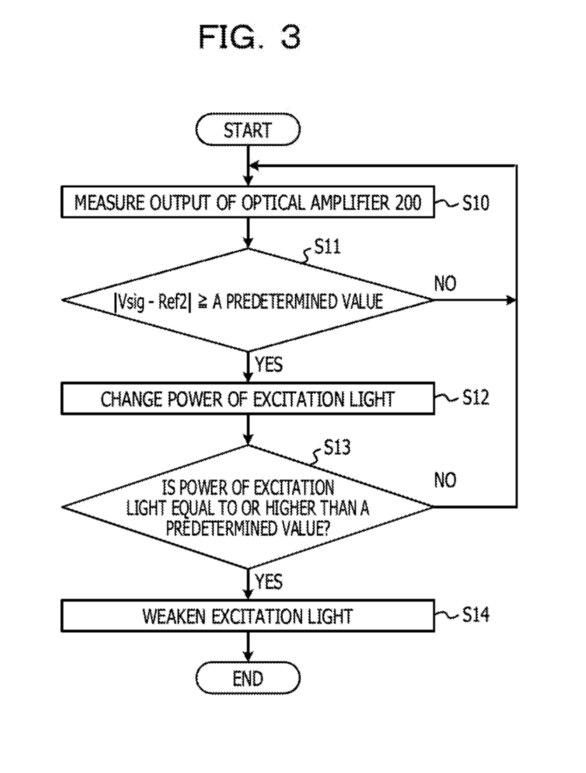

FIG. 3 is a flowchart illustrating control of the excitation light control unit 270 from when the excitation light generation unit 260 generates excitation light to when the excitation light generation unit 260 weakens the power of the excitation light. Following, a description will be given of control of the excitation light control unit 270 by using the flowchart in FIG. 3.

First, in order to obtain the output signal light amplified by the excitation light, the excitation light control unit 270 causes the monitoring unit 250 to measure (monitor) the power of the signal light C′ branched by the branching unit 210. In accordance with this measurement, the power of the signal light C′ is converted into a parameter (Isig) of the current value (S10).

Next, the excitation light control unit 270 converts the measured value (Isig) into a parameter of a voltage value and compares the level of the signal (Vsig) and the reference potential (Ref2) based on the converted signal (Vsig). The comparison is made by the signal comparison unit 272b (S11).

If the difference between the level of the monitor signal (Vsig) and the reference potential (Ref2) is less than a predetermined value (a value calculated based on the specification of the transmission device) (S11: NO), the processing proceeds to S10.

If the difference between the level of the monitor signal (Vsig) and the reference potential (Ref2) is equal to or higher than the predetermined value (S11: YES), the excitation light control unit 270 changes the power of the excitation light so that the signal (Vsig) power approaches the value of the reference potential (Ref2). Specifically, the signal comparison unit 272b changes the signal VCONT so as to change the power of the excitation light (S12).

Next, after the power of the excitation light is changed in S12, the excitation light control unit 270 determines whether or not the power of the excitation light exceeds a predetermined value. If the power of the excitation light exceeds the predetermined value, the excitation light control unit 270 weakens the power of the excitation light. As a method of measuring the power of the excitation light, for example, the measurement is performed by measuring the potential of the drive circuit of the excitation light source in the excitation light generation unit 260 and converting the measurement result to the power of the excitation light (S13).

In this manner, if the power of the excitation light is less than the predetermined value as a result of the determination, that is to say, if the potential at which the excitation light generation unit 260 (the drive circuit of the internal excitation light source) is driven is less than the reference potential (Ref3) (S13: NO), the processing proceeds to S10.

On the other hand, if the power of the excitation light is equal to or higher than the predetermined value, that is to say, the potential at which the excitation light generation unit 260 (the drive circuit of the internal excitation light source) is driven is equal to or higher than the reference potential (Ref3) (S13: YES), the signal comparator 272c performs control so as to weaken the power of the excitation light. At this time, the signal comparison unit 272c transmits a signal for stopping emission of the excitation light to the output control unit 273 so as to control for stopping emission of the output excitation light, for example.

In this manner, if the signal comparison unit 272c has transmitted a signal for stopping emission of the excitation light to the output control unit 273, the output control unit 273 controls the excitation light generation unit 260 so that the excitation light generation unit 260 weakens the power of the excitation light (or stops emission of the excitation light) (S14) and terminates the processing.

By performing the processing as described above, (for example, in the state before signal light is input, or the like) if the power of the excitation light has increased to exceed the normal use range in the state in which signal light is input, it becomes possible to weaken the power of the excitation light. That is to say, when the signal light is input next, it is possible to avoid corruption and deterioration of parts disposed at the subsequent stage of the optical amplifier 200, which are caused by an abrupt increase of the output signal light.

Next, a description will be given of the measurement of the input signal light C′ in the monitoring unit 250.

When signal light is input in the state in which the excitation light generation unit 260 is not outputting the excitation light, a value of the power loss of the signal light differs in accordance with the mode of the optical amplification unit 230. In the same manner, a value of a predetermined power loss differs in accordance with the branching ratio in the branching unit 210.

The power loss in the optical amplification unit 230 is, for example, if the amplification medium is an EDF, the power loss of about 5 dB, about 10 dB, and about 15 dB occurs at the lengths of 1.5 m, 4 m, and 10 m respectively. The power loss of the branching unit 210 becomes about 10 dB if the branching ratio (the ratio to be output to the monitoring unit is 10) is 90:10, for example.

When an attempt is made to minimize the optical amplifier 200, an amplification medium (for example, an erbium doped optical fiber: EDF) used for the optical amplification unit 230 has to be shortened, and thus the power loss described above becomes small.

For example, a current MSA compliant (70×90×15 mm) optical amplifier is about 10 times as great in volume as a highly convenient pluggable type (for example, 18×70×8.5 mm) optical amplifier. Also, the miniaturization makes the optical amplification medium itself short. A pluggable type optical amplifier is small in size compared with an MSA compliant optical amplifier, and both amplifiers have a detachable structure. Accordingly, it is possible to easily attach or detach the amplifier to or from a transmission device.

Referring back to the description of the measurement of input signal light. In the measurement of input signal light, if there is input signal light, the power of the input signal light indicates a value of −20 dBm or higher. If there are no input signals, and only noise light is input, the power of the input signal light indicates a value of less than or equal to −40 dBm. Following, a description will be given on such an assumption, but the measurement is not limited to this. There is a limitation to the measurable range by the monitoring unit 250. Accordingly, if the power of the input signal light C′ of the monitoring unit is equal to or higher than −40 dBm, the measurement is possible, and if the power of the input signal light C′ is less than −40 dBm, the measurement is not possible. A description will be given on such an assumption, but the measurement is not limited to this.

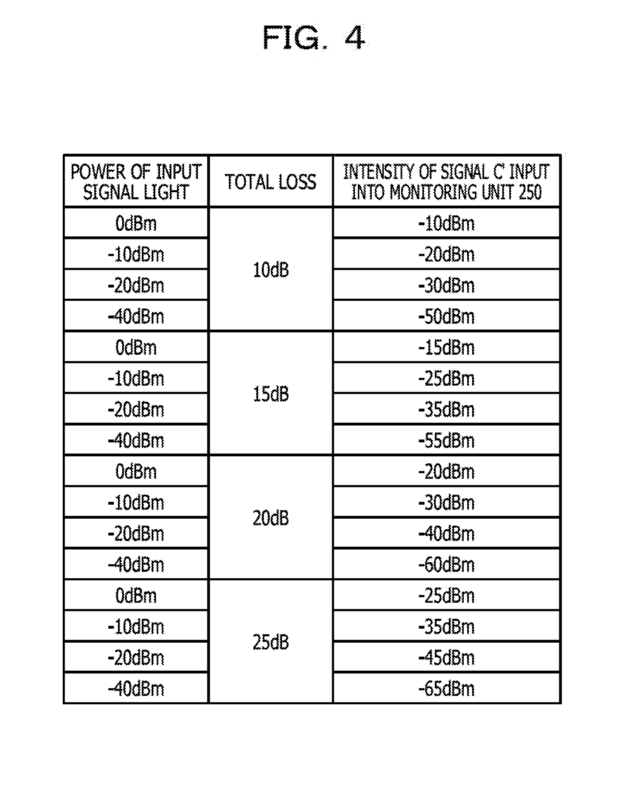

FIG. 4 illustrates a list of relationships among the power of input signal light to the optical amplifier 200, the total power loss generated in the optical amplification unit 230 and the branching unit 210, and the power of the signal light input into the monitoring unit 250. The list illustrated in FIG. 4 illustrates the measurement power of the monitoring unit 250 (the signal light C′ that is input thereto) when the input power is 0, −10, −20, −40 dBm, and the total loss value of the optical amplification unit 230 and the branching unit 210 is 10 to 25 dB (at 5-dB intervals).

From FIG. 4, it is understood that when the minimum input power is −20 dBm, and if the power of the input signal light C′ becomes equal to or higher than −40 dB, the total loss becomes less than or equal to 20. If noise light is only input, that is to say, if the maximum power is −40 dBm, and the power less than −40 dBm is input the monitoring unit 250, it is not possible to measure the power. Thereby, it is not possible for the monitoring unit 250 to measure the power of the input signal light C′ (regardless of the magnitude of the total loss).

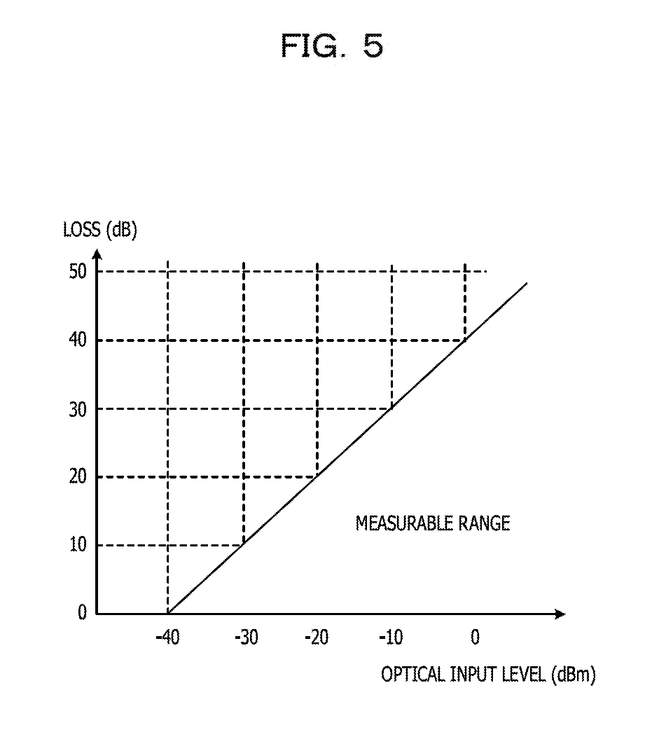

FIG. 5 is a diagram illustrating the measurable range when the optical input level (horizontal axis) indicating the power of the input signal light and the total loss (vertical axis) are used as parameters. The total loss is the total value of the power loss in the optical amplification unit 230 and the power loss in the branching unit 210.

In this manner, concerning the measurable range of the input signal light, if the power of the input signal light is equal to or less than −40 dBm, it is not possible for the monitoring unit 250 to detect the signal power of the input signal light. Accordingly, the excitation light generation unit 260 does not output the excitation light. For the total loss, the power loss in the optical amplification unit 230 and the power loss in the branching unit 210 constitute the majority of the power loss, but there is also the total loss by the optical isolator 240 (although a little) in addition.

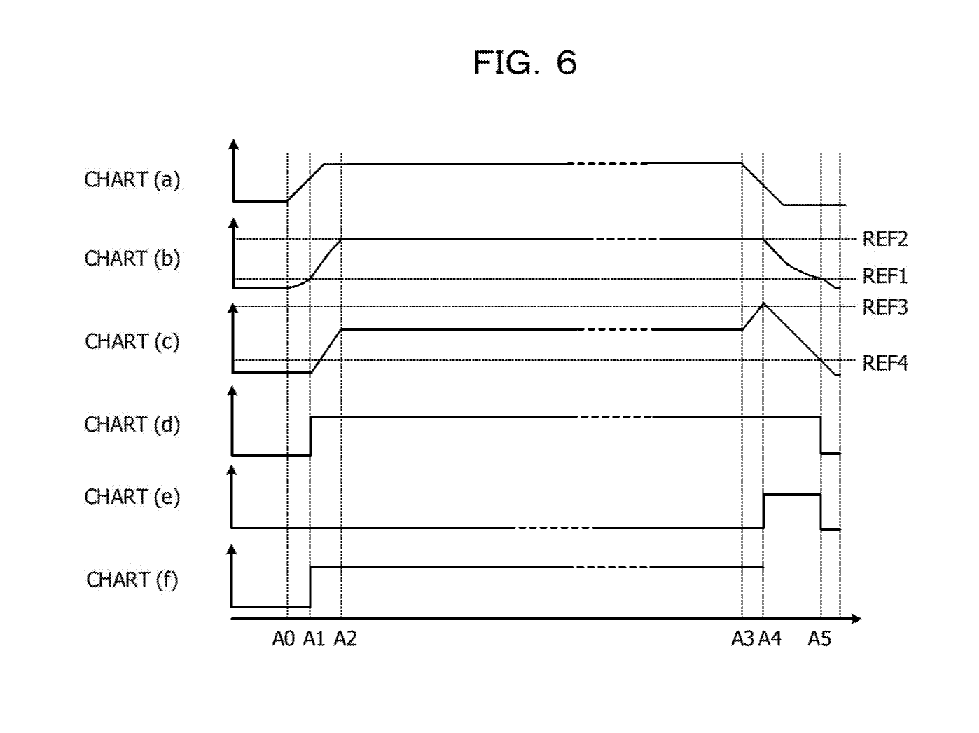

FIG. 6 illustrates an example of a time chart. A logic circuit of non-exclusive OR is used as the output control unit 273.

In the time chart in FIG. 6, the input power (chart (a)), the output power (chart (b)) of the signal, the power transition (chart (c)) of the excitation light, the output (chart (d)) of the signal comparison unit 272a, the output (chart (e)) of the signal comparison unit 272c, and the output (chart (f)) of the output control unit 273 are illustrated.

In “chart (b)” and “chart (c)”, which are illustrated as the time charts in FIG. 6, for convenience of explanation, the reference potentials (Ref 1 to 4) that are input into the signal comparison units 272a, 272b, and 272c are converted into the power of the excitation light and are displayed as reference potentials (REF1 to REF4).

Unlike in the other charts, in “chart (d)”, “chart (e)”, and “chart (f)”, the level of “High” or “Low” is illustrated. In place of “High” or “Low”, “1” or “0” may be used.

As described above, in “chart (a)”, the power of the input signal light is illustrated. At the timing of A0 when the signal in “chart (a)” rises, the signal light is input.

In “chart (b)”, the power of the output signal light is illustrated. The timing when the output signal becomes the power exceeding a predetermined reference value (REF1) is A1. At the timing A1, the output of the signal comparison unit 272a illustrated in “chart (d)” changes from “Low” to “High”. The output of the output control unit 273 illustrated in “chart (f)” changes from “Low” to “High”. As a result, the excitation light illustrated in “chart (c)” is turned on (rises), and the excitation light generation unit 260 starts outputting the excitation light.

The excitation light control unit 270 changes the power of the excitation light until the output power of the optical amplifier 200 becomes the reference value (REF2) based on the power of the input signal light and the power of the excitation light (A2). Until the point in time of A4, the ALC by the power of the input signal light is performed. Reference symbol A3 indicates the point in time when the input signal light is lost (turned off) while the ALC is performed. From this time, the power of the excitation light starts rising by the influence of the ALC and the turning off of the input signal light.

When the power of the excitation light illustrated in “chart (c)” exceeds the reference value (REF3) (A4), the signal comparison unit 272c outputs “High” illustrated in “chart (e)” is output. As a result, the output of the output control unit 273, which is illustrated in “chart (f)”, is turned to “Low” and the power of the excitation light is gradually weakened.

When the power of the output signal light, which is illustrated in “chart (b)”, becomes lower than the reference value (REF1), the output of the signal comparison unit 272a, which is illustrated in “chart (d)”, is changed to “Low”. The output of the signal comparison unit 272c, which is illustrated in “chart (e)”, is also changed to “Low” substantially at the same time with the change of the signal comparison unit 272a to “Low”, and thus the output of the output control unit 273″, which is illustrated in “chart (f)”, remains as “Low”.

As described above, even if the optical output fixed control is performed, it becomes possible to detect the intensity of the input signal light with high precision without using a detecting circuit of the intensity of the input signal light.

It becomes possible to determine whether or not there is input signal light by the power of the excitation light. In particular, there is an advantage of enabling the determination described above regardless of a time constant related to the control speed of the ALC, or the like.

When there is no input signal light, it is possible to reduce the output of the excitation light, and thus it is possible to reduce power consumption.

As described above, in the first embodiment, even if the optical output fixed control is performed, it becomes possible to detect the intensity of the input signal light with high precision without using a detecting circuit of the intensity of the input signal light.

The control (on/off control) of the excitation light is performed using the information regarding the power of the excitation light, and thus it becomes possible to perform control (on/off control) of the excitation light by only the measurement of the output side. Accordingly, it becomes possible to realize miniaturization of the optical amplifier 200.

### Second Embodiment

In the first embodiment, a description has been given of a method of adjusting the power of the excitation light in accordance with the existence of the input signal light using the information on the power of the excitation light.

In a second embodiment, a description will be given of a method of making a comparison using a value close to the real value of the measurement place in consideration of the path loss up to the measurement, which occurs by the existence of the output of the excitation light.

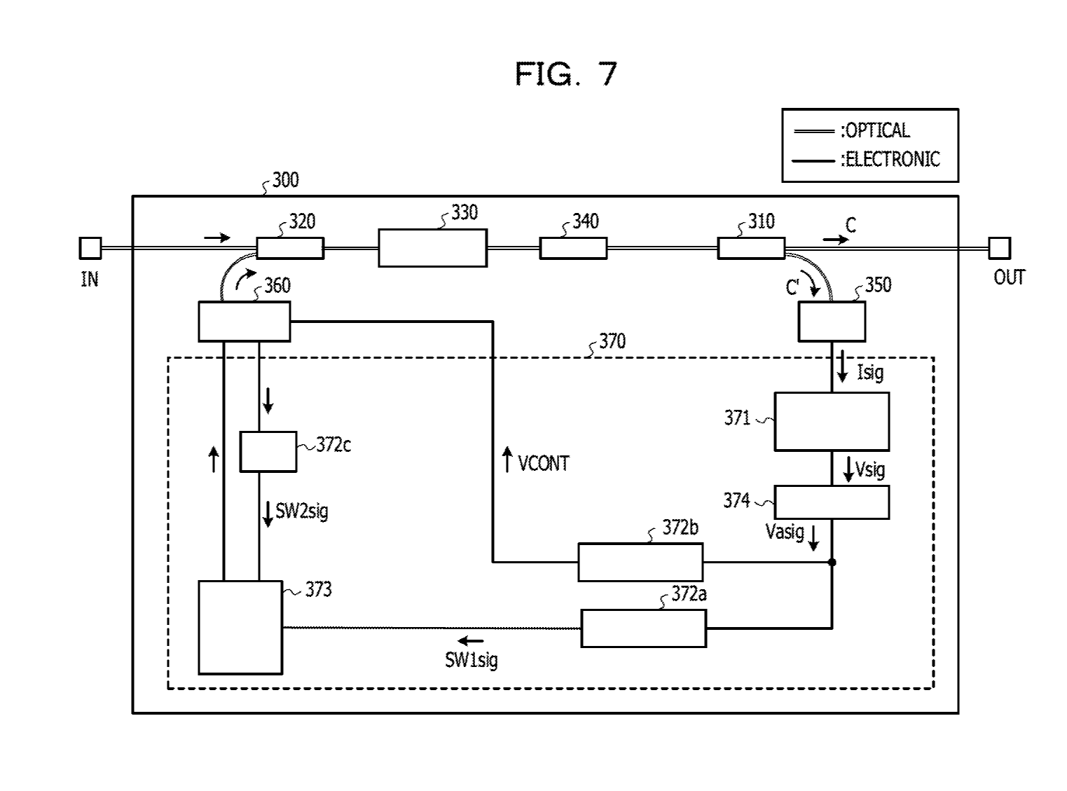

FIG. 7 illustrates an example of a configuration diagram of an optical amplifier 300 according to the second embodiment. The optical amplifier 300 includes a branching unit 310, a multiplexing unit 320, an optical amplification unit 330, an optical isolator 340, a monitoring unit 350, an excitation light generation unit 360, and an excitation light control unit 370. The branching unit 310, the multiplexing unit 320, the optical amplification unit 330, the optical isolator 340, the monitoring unit 350, and the excitation light generation unit 360 are the same as the branching unit 210, the multiplexing unit 220, the optical amplification unit 230, the optical isolator 240, the monitoring unit 250, and the excitation light generation unit 260 in FIG. 2, and thus their descriptions will be omitted.

The excitation light control unit 370 includes a current-to-voltage conversion unit 371, signal comparison units 372a, 372b and 372c, an output control unit 373, and an electric-stage amplification unit 374. The current-to-voltage conversion unit 371, the signal comparison units 372a, 372b and 372c, and the output control unit 373 are the same as the current-to-voltage conversion unit 271, the signal comparison units 272a, 272b and 272c, and the output control unit 273 in FIG. 2, and thus their descriptions will be omitted.

The amplification unit 374 performs amplification due to the loss caused by a path loss, or the like on the signal (Vsig) based on the power of the signal light measured by the monitoring unit 350, and outputs the amplified signal (Vasig). The amplification unit 374 varies depending on the existence of the output of the excitation light, and the larger the loss, the larger the gain. Specifically, if the excitation light is output, the loss becomes small, and thus the gain becomes small. However, if the stop processing is performed, this does not apply.

It is possible to realize the amplification unit 374 using a variable amplifier that controls the driving potential of the amplification circuit, a storage medium, such as a memory storing information, a comparator, or the like, for example.

Here, a description will be given of gain switching of the electric-stage amplifier 374.

Before and after performing output of the excitation light, the difference (the amount of attenuation and amplification) in the optical amplification unit 330 is large, and thus the difference arises in the measurement result of the monitoring unit 350.

The signal comparison unit 372a checks whether or not the signal is higher than the reference potential (Ref1), and thus even if the switching potential has a small gain (the same as the state in which the excitation light is output), the input signal light exceeding the reference potential (Ref1) does not have to be considered.

The reference value for switching the gain is set higher than the maximum value of the input signal light unable to exceed the reference potential (Ref1) if the gain is small.

In short, the place where the signal that exceeds the reference potential (Ref1) value in the signal comparison circuit 372a even if the gain is small is used as a threshold value.

As described above, in the second embodiment, it becomes possible to make a signal comparison at a value close to the real value of the measurement place, and thus it becomes possible to perform control of the excitation light with higher precision.

### Third Embodiment

In the second embodiment, the gain is changed in accordance with the signal (Vsig) value, and the excitation light is controlled by comparing the signals with a value close to the real value.

In a third embodiment, a description will be given of a method of changing the gain based on the on/off control of the excitation light.

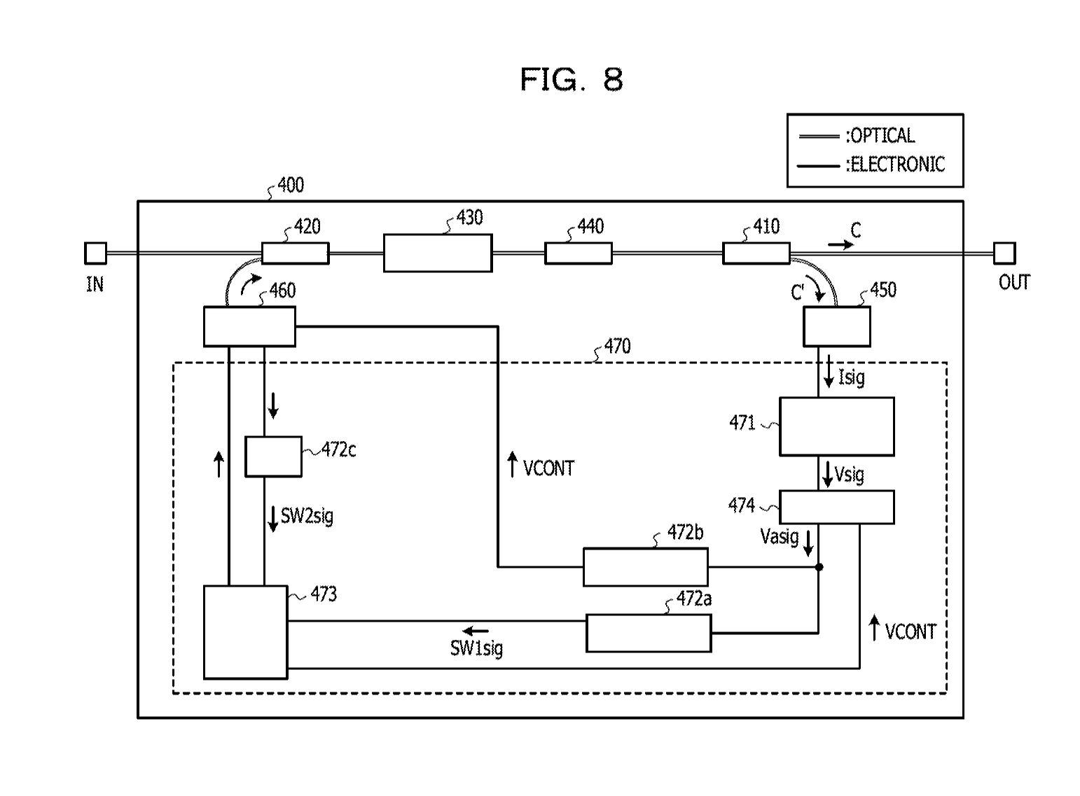

FIG. 8 illustrates an example of a configuration diagram of an optical amplifier 400 according to the third embodiment. The optical amplifier 400 includes a branching unit 410, a multiplexing unit 420, an optical amplification unit 430, an optical isolator 440, a monitoring unit 450, an excitation light generation unit 460, and an excitation light control unit 470. The branching unit 410, the multiplexing unit 420, the optical amplification unit 430, the optical isolator 440, the monitoring unit 450, and the excitation light generation unit 460 are the same as the branching unit 310, the multiplexing unit 320, the optical amplification unit 330, the optical isolator 340, the monitoring unit 350, and the excitation light generation unit 360 in FIG. 7 respectively, and thus their descriptions will be omitted.

The excitation light control unit 470 includes a current-to-voltage conversion unit 471, signal comparison units 472a, 472b and 472c, an output control unit 473, and an electric-stage amplification unit 474. The current-to-voltage conversion unit 471, the signal comparison units 472a, 472b and 472c are the same as the current-to-voltage conversion unit 371, and the signal comparison units 372a, 372b and 372c in FIG. 7 respectively, and their descriptions will be omitted.

The output control unit 473 sends a gain control signal (Vcont (for example, “High” or “Low”)) to the amplification unit 474 in addition to the functions of the output control unit 373 in FIG. 7.

The amplification unit 474 changes the gain based on the signal (Vcont) from the output control unit 473.

When the output control unit 473 performs control for causing the excitation light generation unit 460 to output the excitation light, the output control unit 473 sends a signal (Vcont (for example, “High”)) that reduces the gain. On the other hand, the output control unit 473 performs control for causing the excitation light generation unit 460 to weaken (stop) the excitation light, the output control unit 473 sends a signal (Vcont (for example, “Low”)) that increases the gain.

The signal is sent as “High” or “Low”, for example. When the “High” signal is sent to the excitation light generation unit 460, the “High” signal is sent to the amplification unit 474 in the same manner so that it becomes possible to control the gain of the amplification unit 474 in accordance with the existence of the output of the excitation light.

As described above, in the third embodiment, the output control unit 473 performs control of the amplification unit 474 in accordance with the existence of the output of the excitation light so that it becomes possible to change the gain in accordance with the existence of the excitation light.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical amplifier that amplifies input light by an excitation effect of a rare earth element-doped optical fiber and outputs output light, the optical amplifier comprising:
a photodiode configured to measure power of the output light;
a converter configured to convert the power of the output light measured by the photodiode into a voltage signal; and
a processor coupled to the converter and configured to:
determine whether a difference between a level of the voltage signal and a predetermined potential is equal to or higher than a first predetermined value,
change power of an excitation light so that the level of the voltage signal approaches the predetermined value, when it is determined that the difference is equal to or higher than the first predetermined value,
determine whether the power of the excitation light is equal to or higher than a second predetermined value, after the power of the excitation light is changed, and
reduce the power of the excitation light, when it is determined that the power of the excitation light is equal to or higher than the second predetermined value.

2. The optical amplifier according to claim 1,
wherein the processor changes the power of the excitation light by changing a drive current supplied to a light source of the excitation light.

3. The optical amplifier according to claim 1,
wherein the processor reduces the power of the excitation light by reducing the power of the excitation light to be lower than a predetermined threshold value.

4. The optical amplifier according to claim 1,
wherein the processor includes an amplifier configured to amplify a measured value of the power of the output light by a predetermined amplification factor, and the amplifier changes the amplification factor in accordance with the power of the excitation light.

5. The optical amplifier according to claim 1,
wherein the photodiode converts the power of the output light to a current value, and the converter converts the current value to the voltage signal.

6. The optical amplifier according to claim 1,
wherein the processor reduces the power of the excitation light by transmitting a signal for stopping the output of the excitation light to a light source of the excitation light.

7. The optical amplifier according to claim 1,
wherein the processor obtains a value of the power of the excitation light by measuring a potential of a drive circuit of a light source of the excitation light and converting the potential into the power of the excitation light.

8. A method of controlling excitation light, executed by a processor included in an optical amplifier that amplifies input light by an excitation effect of a rare earth element-doped optical fiber and outputs output light, the method comprising:
converting power of the output light measured by a photodiode included in the optical amplifier into a voltage signal;
determining whether a difference between a level of the voltage signal and a predetermined potential is equal to or higher than a first predetermined value;
changing the power of the excitation light so that the level of the voltage signal approaches the predetermined value, when it is determined that the difference is equal to or higher than the first predetermined value;
determining whether the power of the excitation light is equal to or higher than a second predetermined value; after the power of the excitation light is changed; and
reducing the power of the excitation light, when it is determined that the power of the excitation light is equal to or higher than the second predetermined value.

9. The method according to claim 8,
wherein the changing includes changing the power of the excitation light by changing a drive current supplied to a light source of the excitation light.

10. The method according to claim 8,
wherein the reducing includes reducing the power of the excitation light by reducing the power of the excitation light to be lower than a predetermined threshold value.
